(19) United States
(12) Patent Application Publication
(10) Pub. No.: US 2021/0073751 A1
(43) Pub. Date: Mar. 11, 2021

(54) GLOBAL MERCHANT GATEWAY

(71) Applicant: VISA INTERNATIONAL SERVICE ASSOCIATION, San Francisco, CA (US)

(72) Inventors: Yung-Mei Lin, Shanghai (CN); Ajit Vilasrao Patil, Singapore (SG); Ruoping Ye, Shanghai (CN)

(21) Appl. No.: 16/564,792

(22) Filed: Sep. 9, 2019

(51) Int. Cl. G06Q 20/02; G06Q 20/40; G06Q 20/32

(52) U.S. Cl. CPC G06Q 20/027; G06Q 20/3276; G06Q 20/3274; G06Q 20/40

(57) ABSTRACT

A gateway system is provided that translates image and other media-based transaction data to another format suitable for processing by a participant in the transaction. Some payment systems use barcodes for image-based transactions while other payment systems use any one of several QR code formats. The gateway system allows a participant to securely upload image-based data which the participant is unable to process. The gateway will return the transaction data in a format usable by the participant for continuing a transaction.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The proliferation of payment methods beyond simple card-based transactions has created a dilemma for both consumers and merchants as to which or how many different payment types each should accept. Supporting every type becomes resource intensive. Failure to support a broad range of payment types may result in lost sales for merchants and denied transactions for consumers. This may be especially true when a consumer travels internationally.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

In some embodiments, both consumers and merchants may be given access to a global gateway that allows secure translation of payment information from one payment standard to another payment standard. For example, if a consumer has an Alicard™ barcode payment identifier but a merchant does not support that standard, the merchant may send the barcode image to a global merchant gateway where the barcode may be translated to a format accepted by the merchant and/or the merchant's acquirer, such as an EMV-QR format. In another example, a merchant may pass a quick-response (QR) code related to a transaction to a consumer. The consumer may not have an application (e.g., wallet app) that accepts that format of a QR code. That is, either the QR code is undecipherable in itself, or if readable, the data stored in the QR code is not formatted so as to be understandable. The consumer may pass the image to the global merchant gateway and receive in return a formatted push transaction for use in passing to a payment network such as a VisaNet™. Other transaction types using biometrics, loyalty programs, sound, visual proximity, etc., may use the global merchant gateway to process a variety payments presented in one format and processed using a different format, especially face-to-face transactions.

### BRIEF DESCRIPTION OF THE DRAWINGS

FIG. 1 illustrates a block diagram of system elements that may be present in a transaction environment using a global merchant gateway in accordance with the current disclosure;

FIG. 2 is a block diagram illustrating a configuration for transaction processing using a global merchant gateway;

FIG. 3 is a block diagram of another configuration for transaction processing using the global merchant gateway;

FIG. 4 is a block diagram of yet another configuration for transaction processing using the global merchant gateway;

FIG. 5 is a flowchart of a method for transaction processing in accordance with the configuration of FIG. 2;

FIG. 6 is a flowchart of a method for transaction processing in accordance with the configuration of FIG. 3; and

FIG. 7 is a flowchart of a method for transaction processing in accordance with the configuration of FIG. 4.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

Prior to the widespread use of smartphones, cash, checks, and financial cards were the mainstays of consumer and many other financial transactions. Historically, financial card transactions initially were embossed transactions, where the card was used to imprint a sales slip. This evolved to magnetic strip swipe transactions and these transactions later became chip-based. The widespread adoption of smartphones with high resolution cameras and displays have changed the landscape of financial transactions. Image-based transactions have rapidly emerged as a preferred technique for completing financial transactions in many countries and is gaining popularity in others. In some countries, such as China, image-based payments have become the primary mechanism for face-to-face transactions. These generally fall into two schemes. In one, the consumer scans an image (e.g., QR code) of the merchant, enters a payment source and amount and completes the transactions. In a variant of this scheme, the merchant may generate a transaction-specific image that includes the payment amount so that after the consumer captures the merchant image, the consumer merely selects a payment source and accepts the transaction. In the second scheme, the merchant scans a consumer's image (e.g., QR code) and generates a payment packet that the consumer uses to select a payment source and approve the amount.

Continuing with China as an example, at one point over 100 systems were competing for a share of image-based transaction processing. Even though some consolidation has occurred in this industry, there is a significance chance that a consumer and a merchant may be using different payment systems resulting in an inability to complete a transaction.

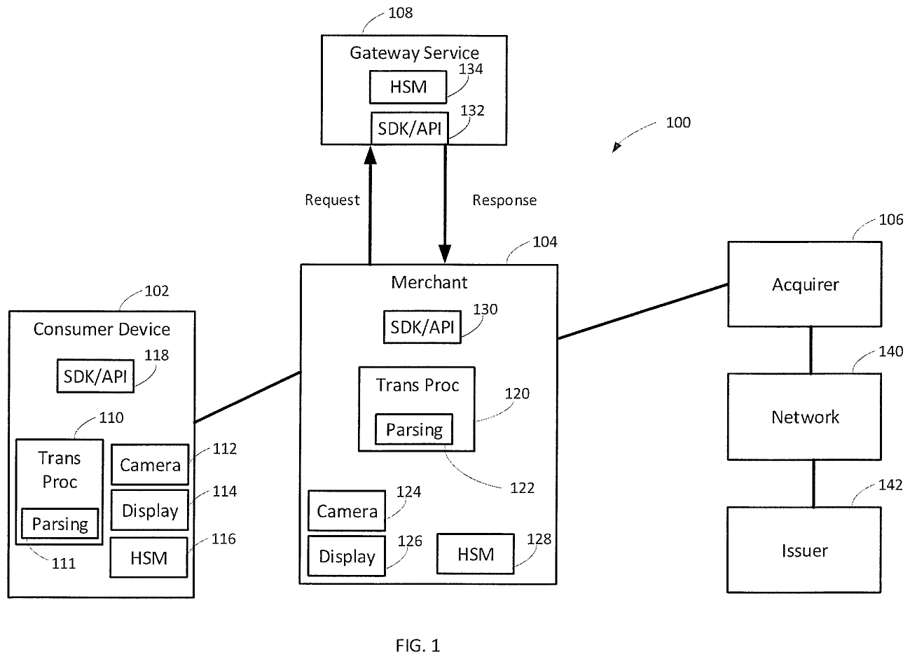

FIG. 1 is an illustration of an exemplary ecosystem 100 for financial transactions. The ecosystem 100 may include a consumer device 102 and a merchant transaction device or simply merchant device 104. The consumer device 102 may be smartphone, tablet, or other device that a consumer may use in a face-to-face transaction. The merchant device 104 may be a point-of-sale device, such as a cash register modified as described below, but in many cases may also be a smartphone or tablet. As in a typical purchase configuration, the merchant may be coupled to an acquirer 106 that may use a financial transaction network 140, such as Visa Net™, to process a transaction with an issuer 142 associated with a consumer using the consumer device 102 to complete a purchase transaction. In the embodiments discussed below, a gateway service 108 may provide support for transactions, particularly face-to-face (F2F) transactions, where a chip card or magnetic stripe card is not used.

For the purpose of this disclosure, a media format uses images, such as barcodes or photographs, as the transport mechanism for data between a consumer and a merchant. A non-media format uses text or ASCII-based data such as that read from a magnetic stripe card as the transport mechanism for data between the consumer and the merchant. As an example, a photograph of a page of text that is transmitted as an image may be media data. That image may then be converted to a non-media formatted machine-readable text file through optical character recognition at the destination. It is understood that image data may be stored as digital binary data both at the source and destination, but the format during the transfer between consumer and merchant devices is one of the concerns in this disclosure. The data may be stored and communicated according to known data protocols to add efficiency and reduce errors in the system.

The consumer device 102 may include a transaction processor 110, such as an application that supports a particular image-based payment scheme. In one embodiment, the transaction processor 110 may interact with other device components such as a camera 112 to capture a merchant payment image. The transaction processor 110 may, in another embodiment, generate an image presented via a display 116 that may be captured by a merchant for making a payment. The processor 110 may also include code for communicating with the merchant 104, the gateway 108 or, depending on a particular implementation another of the downstream participants, the acquirer 106, the network 140, or the issuer 142. A parsing function 111 may use embedded data converters to process captured images received via the camera 112 to determine if the format is understood and if the data present in the image, if in a standard format represents data fields that correspond to the ecosystem in which the transaction processor 110 participates. Actions associated with the parsing function are discussed in more detail below.

The transaction processor 110 may also use the services of a hardware security module (HSM) 128 for various security-related functions such as encrypting/decrypting, signature processing, and key storage. A software development kit (SDK) or application programming interface (API) 118 may allow programmatic access to the methods and tools allowing connection to the gateway service 108 for processing of payment types that are not locally supported.

The merchant device 104 may include a transaction processor 120 that, similar to the consumer device 102, may support various image-based transactions using embedded data converters. These may include merchant-presented image as well as consumer-presented image transactions as described above. A parsing function 122 may perform a similar function to that described above, that is, to determine if the data represented in a captured image is readable, and if so, if it corresponds to a known payment system supported by the owner/operator of the merchant device 104. The merchant device 104 may also include a camera 124 and a display 126 for capturing and displaying, respectively, images associated with a payment transaction. An HSM 128 may support cryptographic functions and key storage. An SDK/API 130 may expose methods for communicating with the gateway service 108 to process transaction types that are not locally supported.

The roles of the acquirer 106, network 140, and issuer 142, where outside those known in current transaction processing, are discussed in more detail below.

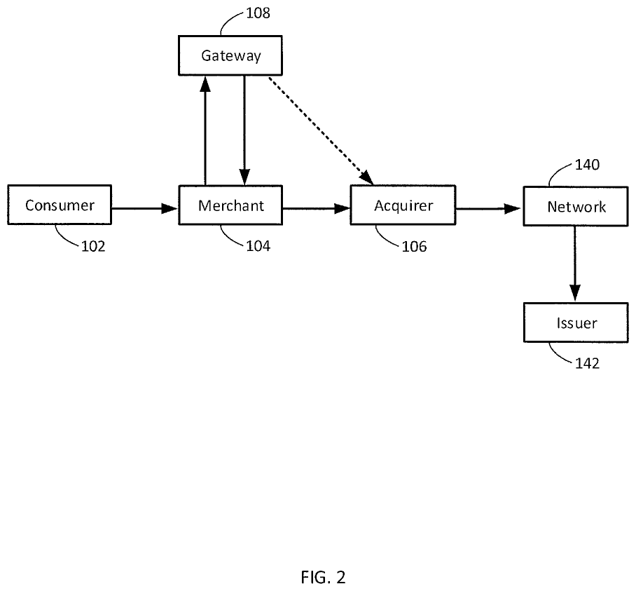

FIG. 2 illustrates an exemplary configuration for executing a transaction using a gateway 108. In this embodiment, a consumer may use the consumer device 102 to present a payment token to the merchant 104. The token may be an image, such as a QR code or bar code, but may also be a biometric such as the consumers face or fingerprint. Other tokens may include sounds, proximity devices, or other identification mechanisms. When the merchant 104 determines that the token cannot be resolved, the token may be passed to the gateway 108. The gateway 108 may return a usable token to the merchant 104. In one embodiment, the returned token may be a new token in similar format, e.g., a new QR code if the original token was a QR code, but in a format usable by the merchant 104. The merchant 104 may then extract the transaction data from the returned token as if it had been received directly from the consumer device 102. In another embodiment, the returned token may be a text or ASCII file representing transaction data extracted from the original token.

The merchant 104 may then send the extracted transaction data, whether received from the gateway 108 as text, an image, or another token format. The merchant's acquirer 106 may process the transaction in a normal manner that may include one or more of authentication, authorization, returning a transaction approval message to the merchant device 104, and settlement via the network 140 and issuer 142. In an embodiment, the gateway 108 may send the returned token directly to the acquirer 106, for example, when the message from the merchant 104 to the gateway 108 specifies that action.

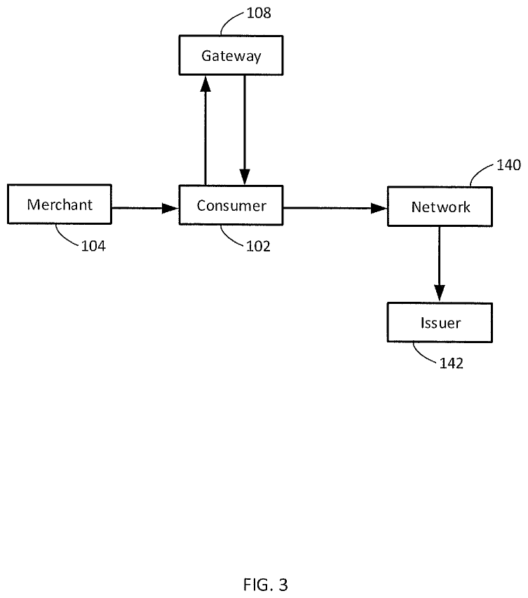

FIG. 3 illustrates another exemplary configuration for executing a transaction using the gateway 108. In this configuration, the merchant 104 may present a token, such as a QR code that the consumer device 102 may capture. As above, if the consumer device 102 cannot process the token, the token may be sent to the gateway 108 along with a request for one or more formats to be used in preparing the response. The returned token may be used by the consumer device 102 to prepare a suitable transaction packet for sending to the network 140. The issuer 142 or another intermediary (not depicted) may then complete the requested transaction.

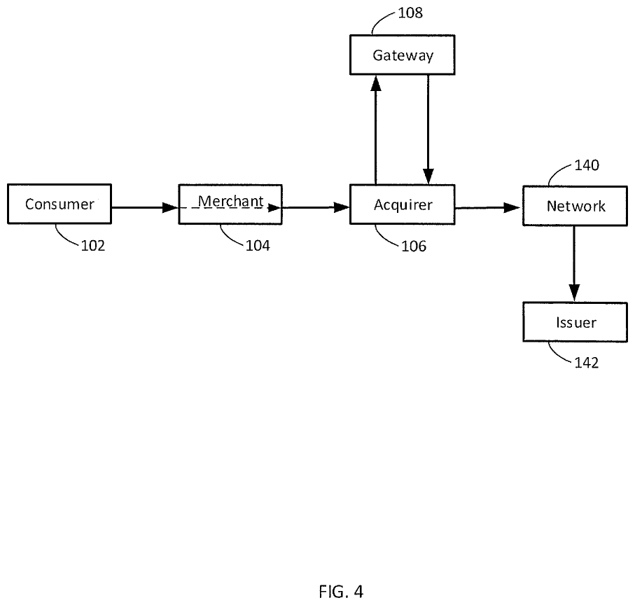

FIG. 4 illustrates yet another exemplary configuration for executing a transaction using the gateway 108. A consumer device 102 may present a token to a merchant device 104. The token may be any of a number of identifiers, including a 2D barcode image representing the consumer account associated with the device 102. In other cases, the token may also include merchant information and a transaction amount. In the illustrated embodiment, the merchant device 104 may ascertain that the token cannot be processed its original format. The merchant device 104 may pass the raw token to its acquirer 106, who in turn may send the token to the gateway 108. The gateway 108 may return a new token in a format designated in the request from the acquirer 106 to the gateway 108. Once the acquirer 106 has the transaction data in a usable format, the transaction may be processed in a conventional manner via a network 140, such as Visa® and an issuer 142, such as a bank.

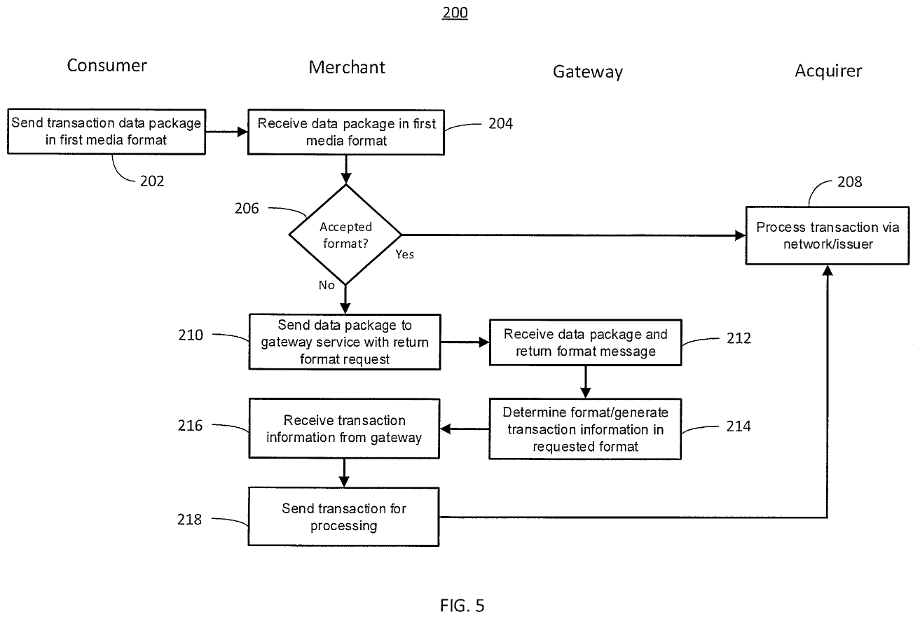

FIG. 5 illustrates a sequence diagram or flowchart 200 associated with the configuration of FIG. 2. At block 202 the consumer device 102 may send a transaction data package in a first media format. The first media format may be a 1D or 2D barcode, for example. The merchant device 104 may, at block 204 receive the data package (token) and determine, at block 206, whether the format as-received can be processed. If yes, the transaction data may be extracted and the transaction processed with the merchant's acquirer 106 at block 208.

If not, the ‘no’ branch from block 206 may be taken to block 210 where the data package received from the consumer device 102 may be formatted into a request along with a request for a format for the response. The request may then be sent to the gateway 108 and received at block 212. The gateway 108 may then, at block 214 determine the format of the incoming token, extract the transaction data from the token and generate a response in the format requested by the merchant 104.

After the formatted data set is received at the merchant device 104 at block 216, the merchant 104 may generate a transaction request at block 218 using the returned data and send the transaction to its acquirer 106 for processing in a normal fashion. The formatted data set may be in a media, e.g. image format, but may in more cases simply be the raw data needed for processing the transaction. In some embodiments, the formatted data set may follow a standard, for example, as ISO 7813 data read from a financial card at a magnetic stripe reader. Once the merchant device 104 has data in the requested format, the transaction data can be formatted as required and sent to the acquirer 106 for processing at block 208 in a conventional manner.

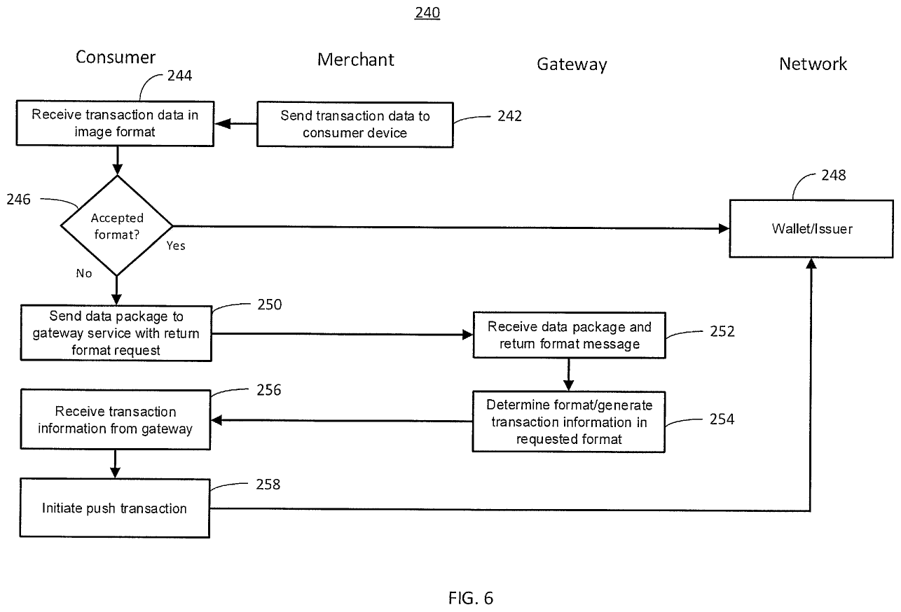

FIG. 6 is a sequence diagram or flowchart 240 illustrating processing corresponding to FIG. 3. In this embodiment, the merchant device 104 may generate, at block 244, a token with transaction information including a transaction value and merchant information. The consumer device 102 may receive the token at block 244 and determine, at block 246, whether the token is in a format usable for processing the transaction. That is, the transaction processor 120 at the consumer device 102 may determine if usable data can be parsed from the token. If so, the consumer device 102 may send the token to its wallet account or issuer 142 for processing.

If the token is not immediately usable, execution may continue at block 250. The consumer device 102 may generate a data package with the token as-received and optionally including a format for data received back from the gateway 108. In some embodiments, the return format may be preset during a registration process. At block 252, the gateway 108 may receive the data package from the consumer device 102 and request response format, if present. At block 254, the gateway 108 may determine the format of the token and extract the embedded transaction information. The gateway 108 may then generate the transaction information into the format requested by the consumer device 102. The transaction information may be received at the consumer device at block 256 and reformatted as necessary to generate compliant data for use in completing the transaction. At block 258, the consumer device 102 may initiate a push transaction with the downstream partner, such as issuer 142. The issuer 142, at block 248, may complete the transaction for whatever product or service is being purchased using conventional processing steps.

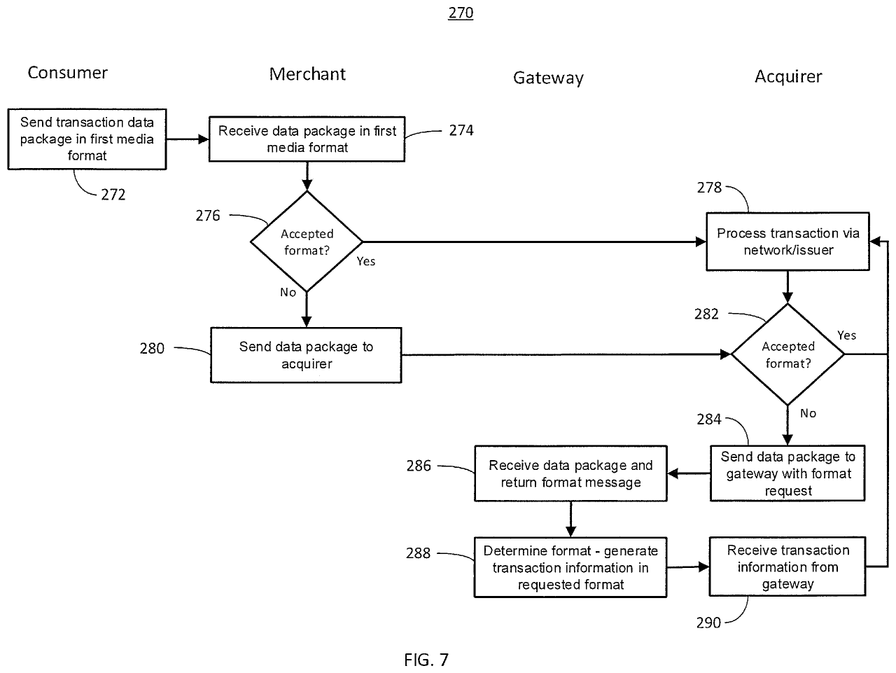

A flowchart 270 illustrated in FIG. 7 is directed to completion of a transaction corresponding to the configuration of FIG. 4. At block 272, the consumer device 102 may present a token incorporating data for a transaction to a merchant device 104. The presentation may be via an image presented on the display 114, such as a barcode, but may also be a data package transferred via a short-range radio, such as Bluetooth® or near-field communication (NFC). At block 274, the merchant device 104 may receive the information, for example, by capturing an image from the display 114 using a camera 124. The merchant device 104, at block 276, may determine if the data can be processed. If so, the transaction data may be sent to the merchant's acquirer 106 for processing in a normal manner. If the data cannot be decoded, the ‘no’ branch from block 276 may be taken to block 280 where the token may be sent to the acquirer 106.

At block 282, the acquirer 106 may determine if the token is in a format that, even though unknown to the merchant device 104 may be known at the acquirer 106. If so, the data may be extracted and the transaction processed at block 278 in a conventional manner. If the acquirer 106 is not able to decode the token, execution may continue at block 284 where the token may be formatted into a data package including the token and optionally, a requested return data format.

At block 286, the gateway 108 may receive the data package from the acquirer 106 and at block 288 determine the format, extract the necessary transaction data and regenerate the transaction data in the requested format. At block 290, the acquirer 106 may receive the processed data in the requested format and may, at block 278, process the transaction in a conventional manner.

In some of the embodiments, application programming interfaces (API) may be used to improve communication and add efficiencies to the system and method. The API may accept and input in a known format or protocol and may response with an output in a known format or protocol. By having known protocols or formats, the inputs may be known and the outputs may be known in advance such that the data may be efficiently processed. In addition, the hardware and software that support the APIs may be continually updated and improved without knowledge of the users of the API which may allow the system and method to continue to evolve over time as new data forms may appear.

A technical effect of the systems and methods described above is a reduced burden on local systems (consumer devices, merchant devices, and even acquirers) to maintain a comprehensive set of conversions for every known transaction data format. A system using this technique may reduce the memory and processing requirements on local systems to a primary set of data types while allowing those same devices to accept a robust repertoire of possible data types and formats. This also lowers the field maintenance requirements for local systems by not requiring constant updates to those systems simply to maintain compatibility with every new or updated system in a marketplace.

Such systems and methods benefit both merchants and consumers by allowing each operate in a primary ecosystem while still allowing transactions with other transaction ecosystems. This may be especially beneficial as payment systems proliferate and as worldwide travel and commerce expand.

The figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of identifying and processing data in an unknown non-textual format, the method comprising:
receiving a data package in a media format in response to a transaction;
determining the data package is in a unknown format;
sending the data package to a third party processor;
receiving from the third party processor a formatted data set representing information embodied in the data package, the formatted data set in a non-media format that is different from the unknown format of the data package; and
submitting the formatted data set to a transaction processing service.

2. The method of claim 1, wherein receiving the data package in the media format comprises receiving the data package at a merchant transaction device.

3. The method of claim 1, wherein receiving the data package in the media format comprises receiving the data package at a consumer electronic device.

4. The method of claim 1, further comprising presenting a transaction approval message responsive to submitting the formatted data set to the transaction processing service.

5. The method of claim 1, wherein determining the data package is in an unknown format comprises decoding the media in the unknown format with one or more embedded data converters to determine that no usable data results from the decoding.

6. The method of claim 1, wherein sending the data package to the third party processor comprises:
formatting the data package into a request package, wherein the request package includes an authentication reference and a requested format for a return formatted data set; and
contacting the third party processor using an application program interface (API) provided by the third party processor, the API exposing methods available from the third party processor.

7. The method of claim 1, further comprising:
processing the formatted data set to include authentication information used by the transaction processing service to complete the transaction.

8. A system for identifying and processing data in an unknown non-textual format, the system comprising:
a first transaction device that participates in a transaction using first transaction data in a first media format;
a second transaction device that participates in the transaction with the first transaction device, the second transaction device configured to participate in the transaction using a second media format;
a gateway service that receives the first transaction data in the first media format via a request message received from the second transaction device, the request including an indication of the second media format, wherein the gateway service i) determines a type of the first media format, ii) extracts the first transaction data using the first media format, iii) reformats the transaction data to the second media format, and iv) returns a response message that includes the transaction data in the second media format for use by the second transaction device in generating a formatted data set.

9. The system of claim 8, wherein the second transaction device includes a hardware security module that encrypts the request message and decrypts the response message.

10. The system of claim 8, wherein the first transaction device is a consumer hand-held device that includes a display that presents the first transaction data in the first media format.

11. The system of claim 10, wherein the second transaction device is a merchant device that includes a camera for accepting the first transaction data in the first media format.

12. The system of claim 10, wherein the second transaction device includes a transaction parsing function that determines that the first media format is unable to be processed at the second transaction device.

13. The system of claim 10, wherein the second transaction device includes a transaction processing function coupled to the transaction parsing function and the gateway service.

14. The system of claim 13, wherein the transaction processing function of the second transaction device is further coupled to a processor that authorizes transactions based on receipt of the formatted data set from the second transaction device.

15. The system of claim 8, wherein the first transaction device is a merchant device that includes a display that presents the first transaction data in the first media format.

16. The system of claim 8, wherein the second transaction device is a hand-held consumer device that includes a camera for accepting the first transaction data in the first media format.

17. A method of identifying and processing data in an unknown non-textual format, the method comprising:
receiving a data package in a media format in response to a transaction;
determining the data package is in a unknown format;
formatting the data package into a request package, wherein the request package includes an authentication reference and a requested format for a return formatted data set;
contacting a third party processor using an application program interface (API) provided by the third party processor, the API exposing methods available from the third party processor;
receiving from the third party processor a formatted data set representing information embodied in the data package, the formatted data set in a non-media format that is different from the unknown format of the data package; and
submitting the formatted data set to a transaction processing service.

18. The method of claim 17, wherein receiving the data package in the media format comprises receiving the data package at a merchant transaction device.

19. The method of claim 17, wherein receiving the data package in the media format comprises receiving the data package at a consumer electronic device.

20. The method of claim 17, wherein determining the data package is in an unknown format comprises decoding the media in the unknown format with one or more embedded data converters to determine that no usable data results from the decoding.
